(19) United States
(12) Patent Application Publication
(10) Pub. No.: US 2008/0296479 A1
(43) Pub. Date: Dec. 4, 2008

(54) Polymer X-Ray Window with Diamond Support Structure

(76) Inventors: Eric C. Anderson, Taylorsville, UT (US); Raymond T. Perkins, Orem, UT (US); Degao Xu, Provo, UT (US); Keith W. Decker, Pleasant Grove, UT (US)

Correspondence Address: THORPE NORTH & WESTERN, LLP., P.O. Box 1219, SANDY, UT, 84091-1219, US

(21) Appl. No.: 11/756,962

(22) Filed: Jun. 1, 2007

(51) Int. Cl. G02B 5/20

(52) U.S. Cl. 250/226; 250/505.1

(57) ABSTRACT

A high strength window for a radiation detection system has a plurality of ribs comprising diamond material. The plurality of ribs defines a grid having openings therein. The tops of the ribs terminate generally in a common plane and the height of the ribs is sufficiently thin to allow some radiation to pass directly through the diamond material of the ribs. The high strength window also has a support frame around a perimeter of the grid. A layer of thin polymer film material is disposed over and spans the plurality of ribs and openings to pass radiation therethrough. A radiation detection system comprises a high strength window as described above and a sensor behind the window. The sensor is configured to detect radiation that passes thought the window.

### FIELD OF THE INVENTION

The present invention relates generally to radiation detection systems and associated high strength radiation detection windows.

### BACKGROUND

Radiation detection systems are used in connection with detecting and sensing emitted radiation. Such systems can be used in connection with electron microscopy, X-ray telescopy, and X-ray spectroscopy. Radiation detection systems typically include in their structure a radiation detection window, which can pass radiation emitted from the radiation source to a radiation detector or sensor, and can also filter or block undesired radiation.

Standard radiation detection windows typically comprise a sheet of material, which is placed over an opening or entrance to the detector. As a general rule, the thickness of the sheet of material corresponds directly to the ability of the material to pass radiation. Accordingly, it is desirable to provide a sheet of material that is as thin as possible, yet capable of withstanding pressure resulting from gravity, normal wear and tear, and differential pressure.

Since it is desirable to minimize thickness in the sheets of material used to pass radiation, it is often necessary to support the thin sheet of material with a support structure. Known support structures include frames, screens, meshes, ribs, and grids. While useful for providing support to an often thin and fragile sheet of material, many support structures, particularly those comprising silicon, are known to interfere with the passage of light through the sheet of material due to the structure's geometry, thickness and/or composition. The interference can be the result of the material composition of the material itself, e.g., silicon. Silicon ribs are set forth in U.S. Pat. No. 4,933,557, which is incorporated herein by reference. The interference can also be the result of the geometry of the support structure, e.g., thickness and/or width of the ribs of the support structure itself.

### SUMMARY OF THE INVENTION

Accordingly, it has been recognized that it would be advantageous to develop a radiation detection system having a high strength, yet thin radiation detection window that is economical to manufacture, and further has the desirable characteristics of being minimally absorptive and minimizing or substantially eliminating interference with the passage of radiation therethrough.

Accordingly, the present invention provides a high strength window for a radiation detection system. The window can include a plurality of ribs comprising a diamond material. The plurality of ribs define and form a grid having openings therein. The tops of the ribs terminate generally in a common plane. As such, each rib can be substantially the same height as the other ribs. Desirably, the height of the ribs is sufficiently thin to allow at least some radiation to pass directly through the diamond material of the ribs.

In one aspect, a support frame is disposed around a perimeter of the grid. The support frame can provide stability to the ribs defining the grid and can also provide structure for securing the radiation detection window to other elements in the radiation detection system. In another aspect, a thin polymer film material is disposed over and spans the plurality of ribs and openings. The thin polymer film material is configured to pass radiation therethrough.

The present invention also provides a radiation detection system. The radiation detection system can include a high strength window as described above, and can further include a sensor. The sensor can be configured to detect radiation that passes through the window.

There has thus been outlined, rather broadly, various features of the invention so that the detailed description thereof that follows may be better understood, and so that the present contribution to the art may be better appreciated. Other features of the present invention will become clearer from the following detailed description of the invention, taken together with the accompanying claims, or may be learned by the practice of the invention.

### BRIEF DESCRIPTION OF THE DRAWINGS

FIG. 1 is a cross-sectional view of a high strength window in accordance with an embodiment of the present invention;

FIG. 2a is a top view of the high strength window of FIG. 1;

FIG. 2b is a photograph of the high strength window of FIG. 2;

FIG. 3a is a top view of another high strength window in accordance with another embodiment of the present invention;

FIG. 3b is a photograph of the high strength window of FIG. 3; and

FIG. 4 is a cross-sectional schematic view of an x-ray detector system in accordance with the present invention with the window of FIG. 1.

### DETAILED DESCRIPTION OF EXAMPLE EMBODIMENTS(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides embodiments pertinent to a high strength window for a radiation detection system and an associated radiation detection system. In accordance with these embodiments, various details are provided herein which are applicable to both the high strength window and the associated radiation detection system.

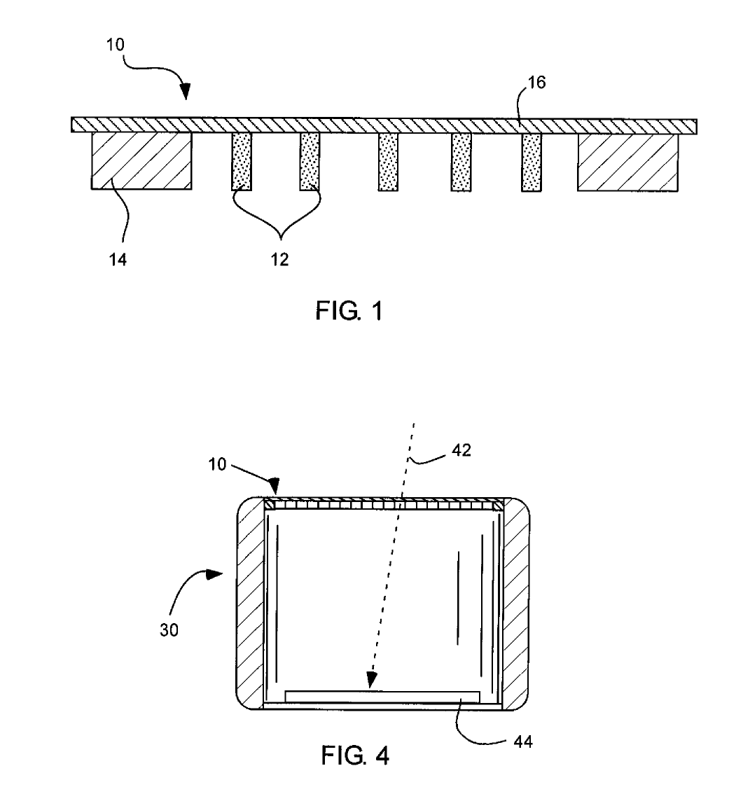

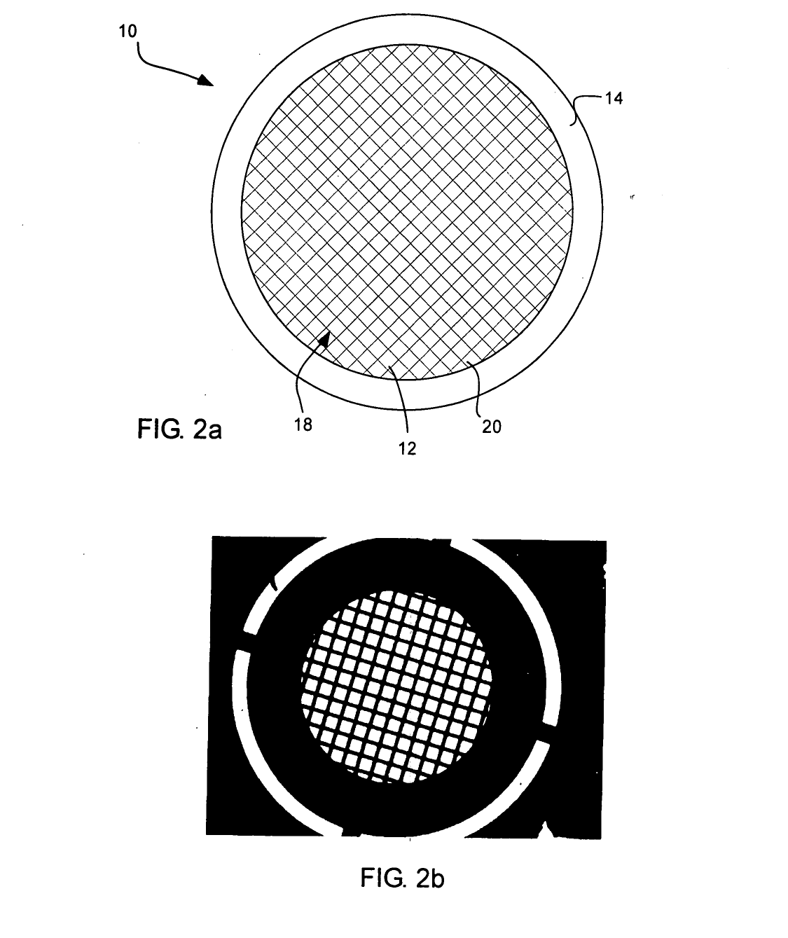

As illustrated in FIGS. 1-2b, a high strength window, indicated generally at 10, is shown in accordance with an exemplary embodiment of the present invention. Specifically, the window 10 is configured for use in connection with a radiation detection system 30 (FIG. 4). The window and associated radiation detection system can be useful for a variety of applications including those associated with electron microscopy, X-ray telescopy, and X-ray spectroscopy. In use, radiation in the form of high energy electrons and high energy photons (indicated by line 42 in FIG. 4) can be directed toward the window of the radiation detection system. The window receives and passes radiation therethrough. Radiation that is passed through the window reaches a sensor 44 (FIG. 4), which generates a signal based on the type and/or amount of radiation it receives.

As described above, the window 10 can be subjected to a variety of operating and environmental conditions, including for example, reduced or elevated pressures, a substantial vacuum, contamination, etc. Such conditions tend to motivate thicker, more robust windows.

Such radiation detection systems, however, can potentially be utilized to sense or detect limited or weak sources. In addition, certain applications require or demand precise measurements. Such systems or applications tend to motivate thinner windows. Support ribs can span the window to provide support to thinner windows. Such supports, however, can introduce stress concentrations into the window due to their structure (such as wire meshes), have different thermal conductivity than the window and introduce thermal stress, and can itself interfere with the radiation directly or even irradiate and introduce noise or errors. For example, silicon ribs can irradiate when subject to radiation. Therefore, it has been recognized that it would be advantageous to develop a window that is thin as possible and as strong as possible and resist introducing noise or interfering with the radiation.

The window 10 of the present invention has a plurality of ribs 12 to support a thin film 16. The plurality of ribs defines a grid 18 which has openings 20 therein. The tops of the ribs terminate generally in a common plane. Accordingly, the ribs can all be substantially the same height or thickness. The ribs 12 can include or can be formed entirely of a diamond material in order to provide a high strength support for the thin film while being as thin as possible. In one aspect, the ribs are sufficiently thin to allow some radiation to pass directly through the diamond material of the ribs. For example, the height of the ribs can range from about 50 μm to about 100 μm.

A support frame 14 is disposed around a perimeter of the grid 18 or ribs 12 and can provide structural support to the ribs and the window in general. The window also has a layer of thin polymer material disposed over and spanning the plurality of ribs and openings to pass radiation therethrough. The support frame can be or can be included as a portion of an enclosure around the sensor of the detection system.

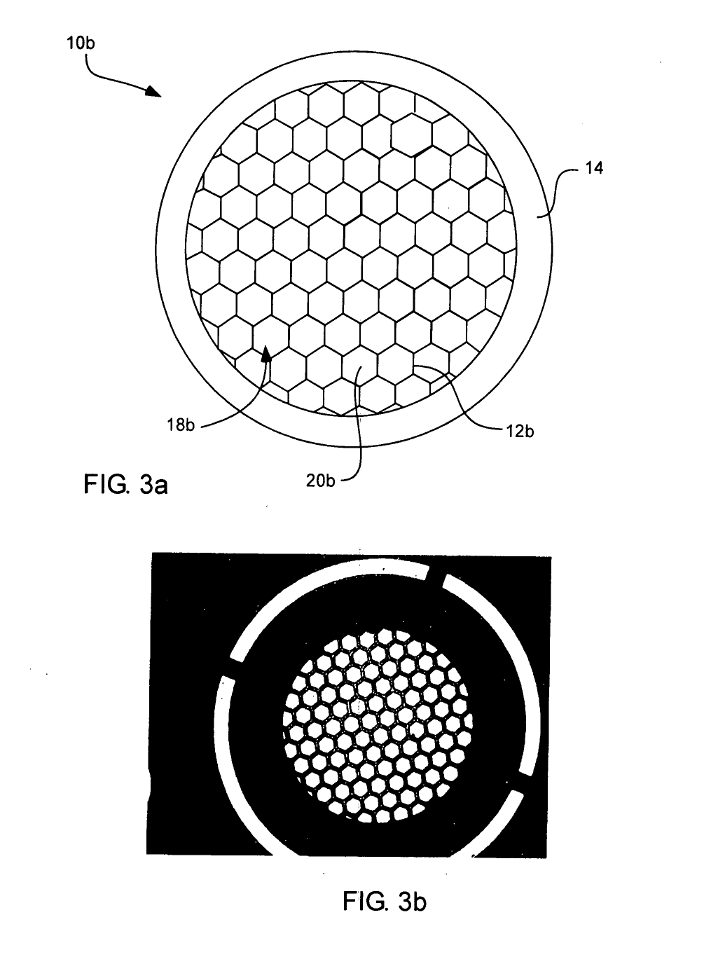

The plurality of ribs 12 can define a grid 18 having a variety of different shaped openings. As shown in FIGS. 2a-3b, the openings can be substantially polygonal. Specifically, FIGS. 2a and 2b illustrate openings that are substantially square in shape. As shown in FIGS. 3a and 3b, a window 10b has ribs 12b defining a grid 18b with openings 20b that are substantially hexagonal. The applicable embodiments should not however be limited to grids having square and hexagonal openings since there are numerous other shapes that may be incorporated into the high strength window, such as circles, ovals, trapezoids, triangles, parallelograms and so forth.

Regardless of the shape of the openings, it is desirable that the openings generally occupy more area within the perimeter of the support frame 14 than the plurality of ribs 12 or grid. This is due to the fact that the openings will typically absorb less radiation than the surrounding ribs and radiation can more freely pass through the openings than through the ribs. In one aspect, the openings take up between about 75% to about 90% of the total area within the perimeter of the support frame. For example, in one embodiment the openings in the grid comprise at least about 75% of the total area within the perimeter of the support frame and the plurality of ribs comprise no more than about 25% of the total area within the perimeter support frame. Alternatively, the openings can comprise at least about 90% of the total area within the support frame, and the plurality of ribs can comprise no more than about 10% of the total area within the frame.

Regarding the material composition of the high strength window 10, the plurality of ribs 12 specifically comprise a diamond material. In one aspect, the diamond material includes polycrystalline diamond (PCD). PCD resists yield or plastic deformation under stress. Therefore, the ribs resist deforming or deflection when exposed to differential pressure, but rather will maintain their shape, thereby providing maximum support to the layer of thin polymer film 16 disposed over the ribs.

Diamond materials have superior mechanical strength and hardness with respect to other materials. Since diamond materials are strong enough that the ribs 12 can be made relatively thin in comparison to ribs made of other materials, such as silicon. For example, the height of the ribs can range from about 50 μm to about 100 μm. This is relatively thin considering that the height of typical silicon grids ranges from over 300 μm to over 700 μm. Another benefit associated with the use of diamond material is that the width of each rib can be minimized, thus increasing the percentage of open space, which is desirable since more radiation can pass through the openings than can pass through the ribs. In one aspect, the width of each rib can range from about 30 μm to about 70 μm.

Further advantages may be realized in light of the thin dimension of the ribs 12, which is achieved via the use of diamond material in the composition thereof. For example, the reduced thickness of the ribs can relax the degree of collimation that is typically required for passing radiation such as X-rays through the ribs. Where materials, such as silicon, have been used in the composition of the ribs, it has been necessary to collimate rays of radiation using a collimator prior to passing the radiation rays through the radiation window. The collimator is used to filter the rays and only allows rays that are substantially perpendicular to the surface of a radiation window to pass therethrough. Collimators can be disadvantageous in that they can reduce the intensity of the signal received by the radiation detector since the collimator blocks and absorbs some radiation rays. Specifically, non-perpendicular rays are absorbed by the material of the collimator, and thus never reach the detector behind the radiation window.

By using diamond in the composition of the ribs 12, the collimation required to pass radiation can be lessened and relaxed since some non-perpendicular radiation rays can pass through the thin diamond ribs. Thus, less radiation is absorbed by the collimator and more radiation is allowed to pass therethrough, resulting in a more accurate signal generated by the sensor. The result is that even with the same open area percentage, the transmission of radiation rays with higher energy from radiation windows having diamond material grids can be higher than that from windows having silicon grids.

In one aspect, the plurality of ribs 12 is configured to substantially eliminate spectral contamination of radiation passing through the high strength window 10. The use of silicon ribs in radiation windows can result in spectral contamination of the radiation since silicon can emit additional X-rays with the radiation of X-rays. On the other hand, ribs comprising diamond material generally do not cause extra spectral contamination since the layer of thin polymer material 16 also contains carbon atoms.

The plurality of ribs 12 can be made by chemical vapor deposition (CVD) techniques, which are known in the art. Specifically, a diamond film can be made by CVD on a silicon substrate, after which the diamond film can be patterned for a radiation window by dry etching methods. Alternatively, the patterned diamond film can also be grown directly on a silicon substrate by CVD and known patterning techniques. In this aspect, the diamond material comprising the ribs can be synthetic diamond.

The thin film 16 is disposed over and spans the plurality of ribs 12 and openings 20. The thin film can include a layer of polymer material, such as poly-vinyl formal (FORMVAR), butvar, parylene, kevlar, polypropylene, lexan or polyimide. In one aspect, the thin film of polymer material avoids punctures, uneven stretching or localized weakening. To reduce the chance of these undesirable characteristics, the tops of the ribs 12 can be rounded and/or polished to eliminate sharp corners and rough surfaces.

The thin film of polymer material should be thick enough to withstand pressures to which it will be exposed, such as gravity, normal wear and tear and the like. However, as thickness of the layer increases so does undesirable absorption of radiation. If radiation is absorbed by the layer of thin material, it will not reach the sensor or detector. This is particularly true with respect to longer X-rays, which are likely to be absorbed by a thicker film. Therefore, it is desirable to provide a layer of thin film that is as thin as possible but sufficiently thick to withstand the pressures explained above. In one aspect, the film will be able to withstand at least one atmosphere of pressure, and thus the film can have a thickness less than about 0.30 μm (300 nm).

In addition, a thin coating can be disposed on the thin film. The thin coating can include boron hydride (BH) and/or aluminum (Al) to prevent transmission of unwanted electromagnetic radiation. In one aspect, the coating can include BH with a thickness of about 20 nm. In another aspect, the coating can be aluminum with a thickness of about 30 nm. The surface of the coating can oxidize spontaneously in air to a depth of about 3 nm. The oxide is transparent to light and so the oxide layers do not contribute to the light blocking capability of the film. The oxide can reduce permeation of nearly all gases and so the layers of BH and/or aluminum oxide increases the resistance of the film to deleterious effects of the environment in which the radiation window is used. The thin coating can also include a gas barrier film layer.

The high strength window 10 also includes a support frame 14 disposed around a perimeter of the grid 18. The support frame can be made of the same material as the plurality of ribs 12 defining the grid. Accordingly, the support frame can include a diamond material. In this case, the support frame can be either integral with the grid or can form a separate piece. Alternatively, the support frame can be made of a material that is different from the diamond material comprising the ribs. In addition to providing support for the grid and the layer of thin polymer film, the support frame can be configured to secure the window to the appropriate location on a radiation detection system.

Referring to FIG. 4, the window 10 can be part of a radiation detection system 40. The radiation detection system 40 can include a high strength window for passing radiation therethrough, which is described in detail in the embodiments set forth above. The radiation detection system 40 also can include a sensor 44 disposed behind the window. The sensor can be configured to detect radiation that passes through the window, and can further be configured to generate a signal based on the amount and/or type of radiation detected. The sensor 44 can be operatively coupled to various signal processing electronics.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A window for a radiation detection system, the window comprising:
a) a plurality of ribs comprising diamond material, the plurality of ribs defining a grid having openings therein, wherein tops of the ribs terminate generally in a common plane, and wherein a height of the ribs is sufficiently thin to allow some radiation to pass directly through the diamond material of the ribs;
b) a support frame around a perimeter of the grid; and
c) a layer of thin polymer film material disposed over and spanning the plurality of ribs and openings capable of passing radiation therethrough.

2. A window as in claim 1, wherein the openings in the grid comprise at least 75% of a total area within the frame, and the plurality of ribs comprise no more than 25% of the total area within the frame.

3. A window as in claim 1, wherein the openings in the grid comprise at least 90% of the total area within the frame, and the plurality of ribs comprise no more than 10% of the total area within the frame.

4. A window as in claim 1, wherein the height of the ribs is from about 50 μm to about 100 μm.

5. A window as in claim 1, wherein a thickness of the film is less than approximately 0.30 μm.

6. A window as in claim 1, wherein the diamond material comprises polycrystalline diamond (PCD).

7. A window as in claim 1, wherein the plurality of ribs is configured to substantially eliminate spectral contamination of radiation passing through the high strength window.

8. A window as in claim 1, further comprising a gas barrier film layer disposed over the layer of thin polymer film material.

9. A window for a radiation detection system, the window comprising:
a) a frame;
b) a plurality of ribs carried by the frame and defining a grid with openings therein;
c) the ribs having a thickness of between approximately 50 to 100 μm;
d) the ribs being formed of a diamond material; and
e) a film disposed over the ribs and spanning the openings;
f) the film including a polymer material; and
g) the film having a thickness less than approximately 0.30 μm.

10. A window as in claim 9, wherein the openings in the grid comprise at least 75% of a total area within the frame, and the plurality of ribs comprise no more than 25% of the total area within the frame.

11. A window as in claim 9, wherein the openings in the grid comprise at least 90% of the total area within the frame, and the plurality of ribs comprise no more than 10% of the total area within the frame.

12. A window as in claim 9, wherein the diamond material comprises polycrystalline diamond (PCD).

13. A radiation detection system comprising:
a) a window for passing radiation therethrough, comprising:
i) a plurality of ribs comprising diamond material, the plurality of ribs defining a grid having openings therein, wherein tops of the ribs terminate substantially in a common plane, and wherein a height of the ribs is sufficiently thin to allow some radiation to pass directly through the diamond material of the ribs;
ii) a support frame around a perimeter of the grid; and
iii) a layer of thin polymer film material disposed over and spanning the plurality of ribs and openings; and
b) a sensor behind the window configured to detect radiation that passes through the window.

14. A window as in claim 13, wherein the openings in the grid comprise at least 75% of a total area within the frame, and the plurality of ribs comprise no more than 25% of the total area within the frame.

15. A window as in claim 13, wherein the openings in the grid comprise at least 90% of the total area within the frame, and the plurality of ribs comprise no more than 10% of the total area within the frame.

16. A window as in claim 13, wherein the height of the ribs is from about 50 μm to about 100 μm.

17. A window as in claim 13, wherein a thickness of the film is less than approximately 0.30 μm.

18. A window as in claim 13, wherein the diamond material comprises polycrystalline diamond (PCD).

19. A window as in claim 13, wherein the plurality of ribs is configured to substantially eliminate spectral contamination of radiation passing through the high strength window.
